(19) United States
(12) Patent Application Publication
(10) Pub. No.: US 2018/0191117 A1
(43) Pub. Date: Jul. 5, 2018

(54) POWER ADAPTOR

(71) Applicant: VogDUO International Corporation, New Taipei City (TW)

(72) Inventor: Chen-Kuo Wu, New Taipei City (TW)

(73) Assignee: VogDUO International Corporation, New Taipei City (TW)

(21) Appl. No.: 15/861,677

(22) Filed: Jan. 4, 2018

Related U.S. Application Data
(60) Provisional application No. 62/442,075, filed on Jan. 4, 2017.

(51) Int. Cl. H01R 35/04; H01R 43/24; H01R 13/405; H01M 10/46; H01R 13/66

(52) U.S. Cl. CPC H01R 35/04; H01R 43/24; H01R 2103/00; H01M 10/46; H01R 13/6675; H01R 13/405

(57) ABSTRACT

A power adaptor including a body and a plug is provided. The plug includes an insulating housing and at least one blade partially inserted into the insulating housing. The insulating housing is connected to the body and includes a base and at least one extending portion extending from the base, a part of the blade protruding out from the base is partially covered by the extending portion. A distance between an edge of the base and the extending portion is D, an extending length of the extending portion is L, a thickness of the extending portion is T, and D²+L²=(D+T)².

### CROSS-REFERENCE TO RELATED APPLICATION

This application claims the priority benefit of U.S. provisional application Ser. No. 62/442,075, filed on Jan. 4, 2017. The entirety of the above-mentioned patent application is hereby incorporated by reference herein and made a part of this specification.

### BACKGROUND

### Technical Field

The disclosure relates to a power adaptor, and particularly relates to a power adaptor has a small thickness.

### Description of Related Art

Nowadays, many portable electronic devices include advanced displays, communication modules, and processing components that consume large amounts of power. In order to be truly portable, a device typically includes an internal battery module to store power for the components to use without requiring a connection to an external power source. Once the stored power is consumed, the battery module must be recharged to ensure that there is an adequate amount of power available for the components. Typically, the battery module is recharged using a direct current (DC) power input.

A power adaptor converts alternating current (AC) power into DC power to charge portable electronic devices. The AC power may be input from an electrical source. The converted DC power is output to one or more portable electronic devices. Sometimes the DC power is provided to the portable device using the Universal Serial Bus (USB) interface.

### SUMMARY

The disclosure provides a power adaptor having a thin plug, so as to reduce the thickness of the power adaptor while satisfying safety requirements.

The power adaptor of the disclosure includes a body and a plug including an insulating housing and at least one blade partially inserted into the insulating housing. The insulating housing is connected to the body and includes a base and at least one extending portion extending from the base, a part of the blade protruding out from the base is partially covered by the extending portion. A distance between an edge of the base and the extending portion is D, an extending length of the extending portion is L, a thickness of the extending portion is T, and D²+L²=(D+T)².

In one embodiment of the disclosure, D²+L²=26.01 mm².

In one embodiment of the disclosure, the extending portion extends from the base along a first direction, the part of the blade protrudes out from the base along the first direction, the distance between the edge of the base and the extending portion along a second direction is D, the extending length of the extending portion along the first direction is L, the thickness of the extending portion along the second direction is T, and the first direction is perpendicular to the second direction.

In one embodiment of the disclosure, the blade comprises a first section and a second section, the first section is embedded in the insulating housing, the second section is connected to the first section and exposed by the insulating housing, and a width of the first section is smaller than a width of the second section.

In one embodiment of the disclosure, a width of the extending portion is equal to the width of the second section.

In one embodiment of the disclosure, the power adaptor further includes a camshaft assembly, and the insulating housing is rotatably connected to the body through the camshaft assembly.

In one embodiment of the disclosure, the body has at least one slot, the insulating housing is rotated through the camshaft assembly to drive the blade to retract within the slot or leave the slot.

In one embodiment of the disclosure, the body has a recess connected to the slot, the insulating housing is at least partially located in the recess.

In one embodiment of the disclosure, the camshaft assembly comprises a cam, an elastic component, and a shaft, the insulating housing is rotatably connected to the body through the shaft, the cam sleeves on the shaft, and the elastic component connects to the body and suspends the plug at different positions.

In one embodiment of the disclosure, the cam is integrally connected to the insulating housing.

In one embodiment of the disclosure, the cam has a plurality of protrusions, and the elastic component has an indentation fitting with any one of the protrusions.

In one embodiment of the disclosure, the indentation moves relatively to the cam from one of the protrusions to another one of the protrusions when the insulating housing is rotated.

In one embodiment of the disclosure, the power adaptor further includes at least one electrical connection component disposed in the body and contacting the shaft.

In one embodiment of the disclosure, the electrical connection component is a pogo pin.

Based on above, in the disclosure, a part of each of the blades protruding out from the base is partially covered by the extending portions. Therefore, it is safer for the user when plugging the power adaptor into the external power source. Further, the condition D²+L²=(D+T)² is satisfied in the disclosure, so the distance between the edge of the base to the exposed blade becomes the shortest distance from the edge of the base to the second section of the blade instead of the distance D, which is the distance between the edge of the base and the extending portion. In other words, the distance between the edge of the base to the exposed blade is equal to square root of (D²+L²) and is equal to (D+T) instead of the distance D. Under the circumstance that the minimum distance between the edge of the base and the exposed blade is required, the sum (D+T) is equal to the minimum distance. That is to say, in the disclosure, the distance D between the edge of the base and the extending portion can be reduced while the condition of required minimum distance is still satisfied by increasing the thickness T so the edge of the base can be designed to locate closer to the extending portion/blade. Therefore, the base of the insulating housing can be designed to have a smaller thickness. Consequently, the plug together with the body can be designed to have a smaller thickness. That is to say, the thickness of the power adaptor is reduced while satisfying safety requirement.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a three dimensional schematic view illustrating a power adaptor with a plug according to one embodiment of the disclosure.

FIG. 2 is a three dimensional schematic view illustrating the plug in FIG. 1.

FIG. 3 is a three dimensional schematic view illustrating the plug in FIG. 1 without a blade.

FIG. 4 is a schematic side view of the plug in FIG. 1.

FIG. 5 is a three dimensional and exploded schematic view of a power adaptor with a plug according to another embodiment of the disclosure.

FIG. 6 is a schematic top view of the power adaptor in FIG. 5.

FIG. 7 is a three dimensional schematic view of a plug in FIG. 5 at a first position.

FIG. 8 is a three dimensional schematic view of the plug in FIG. 5 at a second position.

FIG. 9 is a three dimensional and partial view illustrating a camshaft assembly in FIG. 5.

FIG. 10 is a schematic side view illustrating an elastic component according to embodiment in FIG. 4.

FIG. 11 is a schematic view illustrating an electrical connection component according to yet another embodiment of the disclosure.

FIG. 12 is a schematic view illustrating electrical connection of a power adaptor according to yet another embodiment of the disclosure.

### DESCRIPTION OF THE EMBODIMENTS

Reference will now be made in detail to the present preferred embodiments of the disclosure, examples of which are illustrated in the accompanying drawings. Wherever possible, the same reference numbers are used in the drawings and the description to refer to the same or like parts.

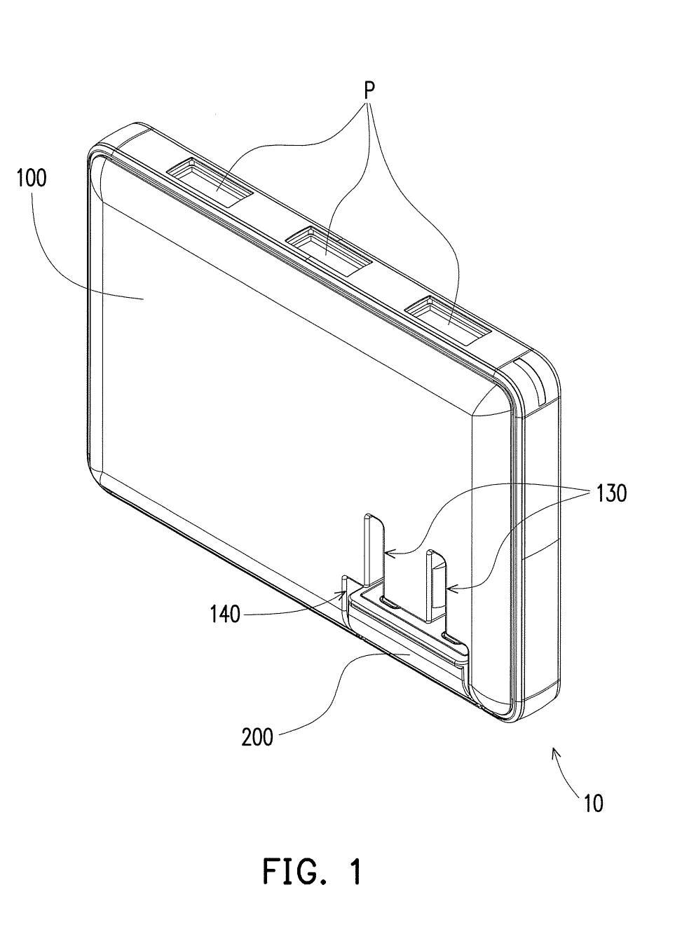

FIG. 1 is a three dimensional schematic view illustrating a power adaptor with a plug according to one embodiment of the disclosure. Referring to FIG. 1, a power adaptor 10 has a body 100 and a plug 200 which can be retracted within the body 100. The plug 200 will be clearly described as follows.

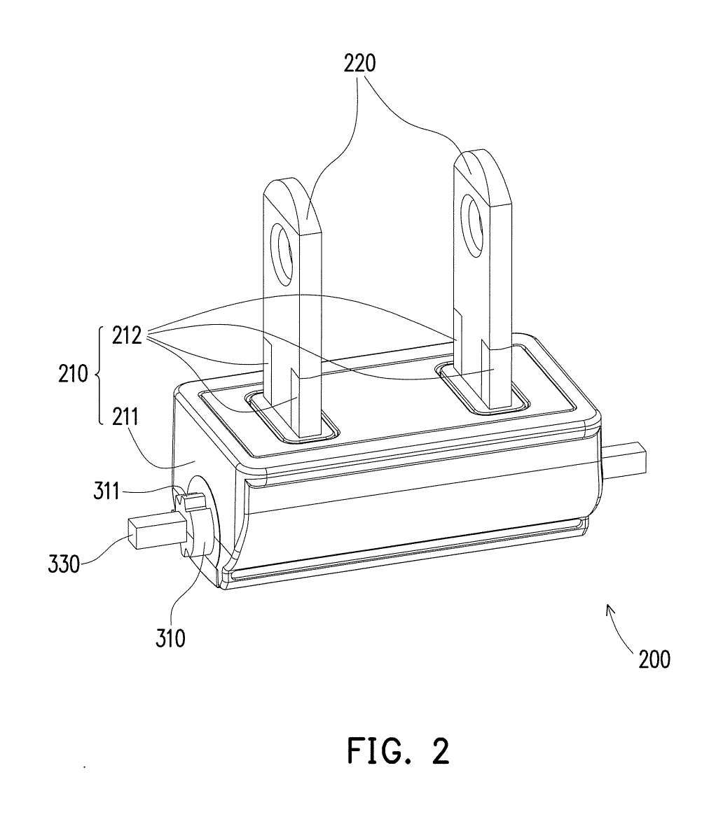

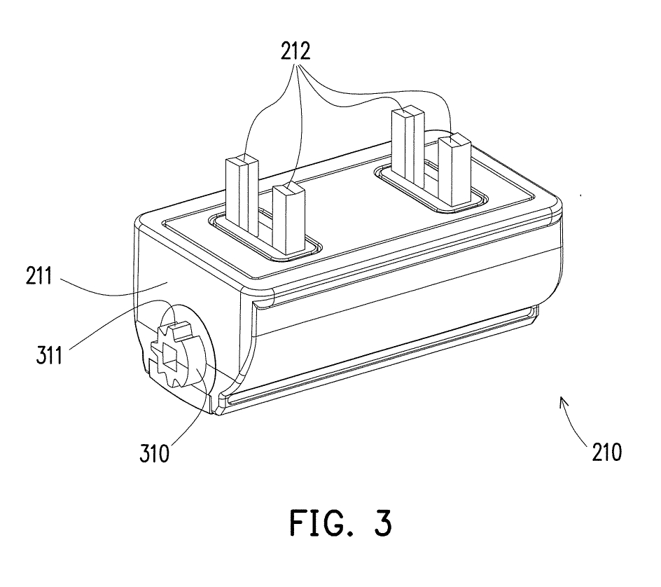

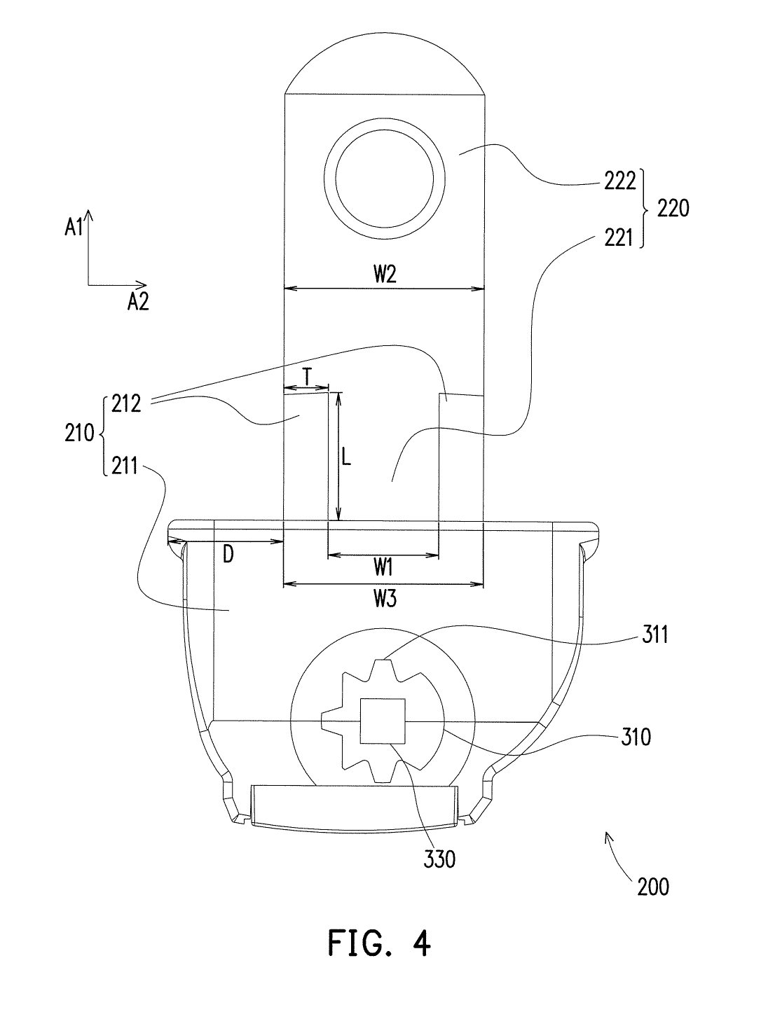

FIG. 2 is a three dimensional schematic view illustrating the plug in FIG. 1, FIG. 3 is a three dimensional schematic view illustrating the plug in FIG. 1 without a blade, and FIG. 4 is a schematic side view of the plug in FIG. 1. Referring to FIGS. 2 to 4 at the same time, the plug 200 includes an insulating housing 210 and at least one blade 220 partially inserted into the insulating housing 210. In the present embodiment, two blades 220 are shown as an example, the disclosure is not limited thereto. The insulating housing 210 is connected to the body 100 of the power adaptor shown in FIG. 1. Additionally, the insulating housing 210 includes a base 211 and at least one extending portion 212 extending from the base 211. In FIGS. 2 and 3, four extending portions 212 are shown as an example, the disclosure is not limited thereto. Further, a part of each of the blades 220 protruding out from the base 211 is partially covered by the extending portions 212, as shown in FIG. 2. It should be noted here, the insulating housing 210 including the base 211 and the extending portions 212 is made of insulating materials. The extending portion 212 is located at the joint of the blade 220 and the base 211 so as to insulate the blade 220. Therefore, it is safer for the user when plugging the power adaptor 10 into the external power source.

Specifically, as shown in FIG. 4, a distance between an edge of the base 211 and the extending portion 212 is D, an extending length of the extending portion 212 is L, and a thickness of the extending portion 212 is T.

In other words, as shown in FIG. 4, the extending portion 212 extends from the base 211 along a first direction A1, a part of the blade 220 protrudes out from the base 211 along the first direction A1, the distance between the edge of the base 211 and the extending portion 212 along a second direction A2 is D, the extending length of the extending portion 212 along the first direction A1 is L, the thickness of the extending portion 212 along the second direction A2 is T, and the first direction A1 is perpendicular to the second direction A2.

Moreover, the distance D, the extending length L, and the thickness T satisfy the condition: D²+L²=(D+T)². In another embodiment, the distance D and the extending length L may satisfy the condition: D²+L²=26.01 mm². The disclosure is not limited thereto. In American safety regulation, the minimum distance between the edge of the base and the exposed blade is greater than or equal to 5.1 mm for safety. Therefore, the design of the plug 200 in this disclosure meets American safety regulation.

Referring to FIG. 4, the blade 220 includes a first section 221 and a second section 222, the first section 221 is embedded in the insulating housing 210, the second section 222 is connected to the first section 221 and exposed by the insulating housing 210, and a width W1 of the first section 221 is smaller than a width W2 of the second section 222. Further, a width W3 of the extending portion 212 is equal to the width W2 of the second section 222.

In other words, the condition D²+L²=(D+T)² is satisfied in the disclosure, so the distance between the edge of the base 211 to the blade 220 becomes the shortest distance from the edge of the base 211 to the second section 222 of the blade 220 instead of the distance D, which is the distance between the edge of the base 211 and the extending portion 212. In other words, the distance between the edge of the base 211 to the exposed portion (the second section 222) of the blade 220 is equal to square root of (D²+L²) and is equal to (D+T) instead of the distance D. Under the circumstance that the minimum distance between the edge of the base 211 and the exposed portion (the second section 222) of the blade 220 is required, the sum (D+T) is equal to the minimum distance. That is to say, in the disclosure, the distance D between the edge of the base 211 and the extending portion 212 can be reduced while the condition of required minimum distance is still satisfied by increasing the thickness T so the edge of the base 211 can be designed to locate closer to the extending portion 212/blade 220. Therefore, the base 211 of the insulating housing 210 can be designed to have a smaller thickness. Consequently, the plug 200 together with the body 100 can be designed to have a smaller thickness. That is to say, the thickness of the power adaptor 10 is reduced while satisfying safety requirement.

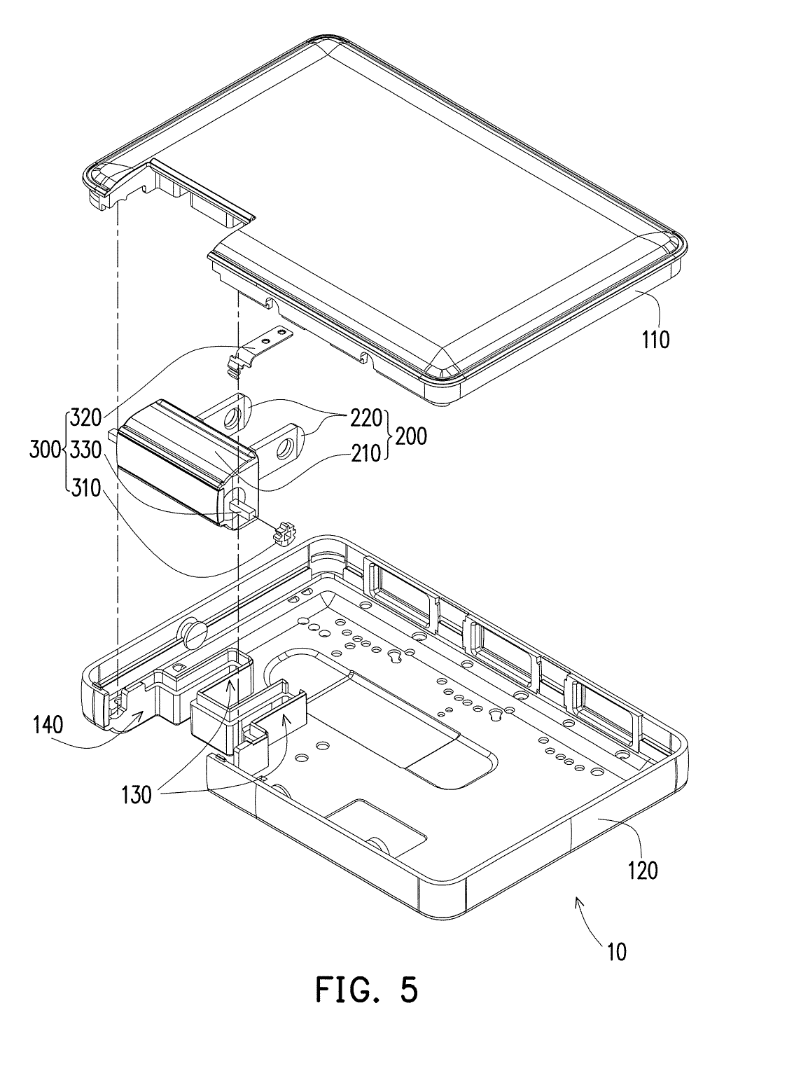

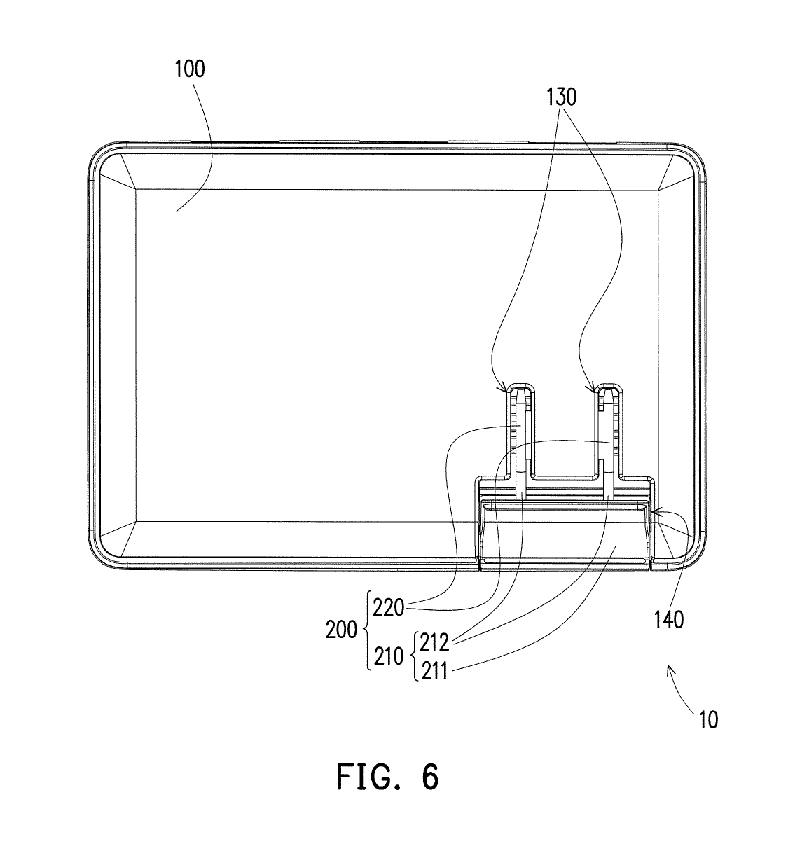

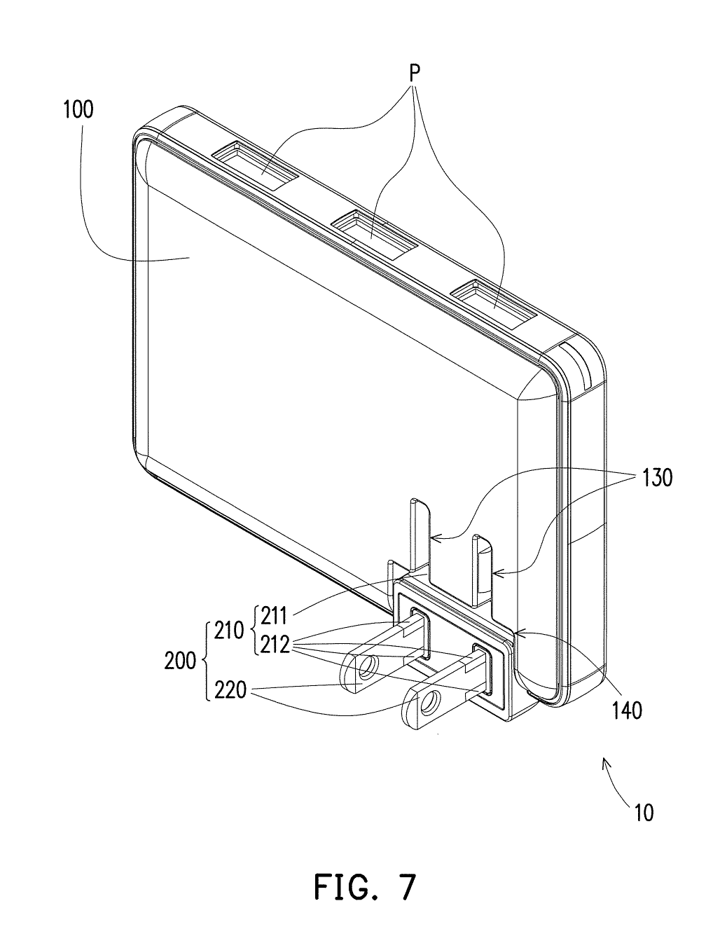

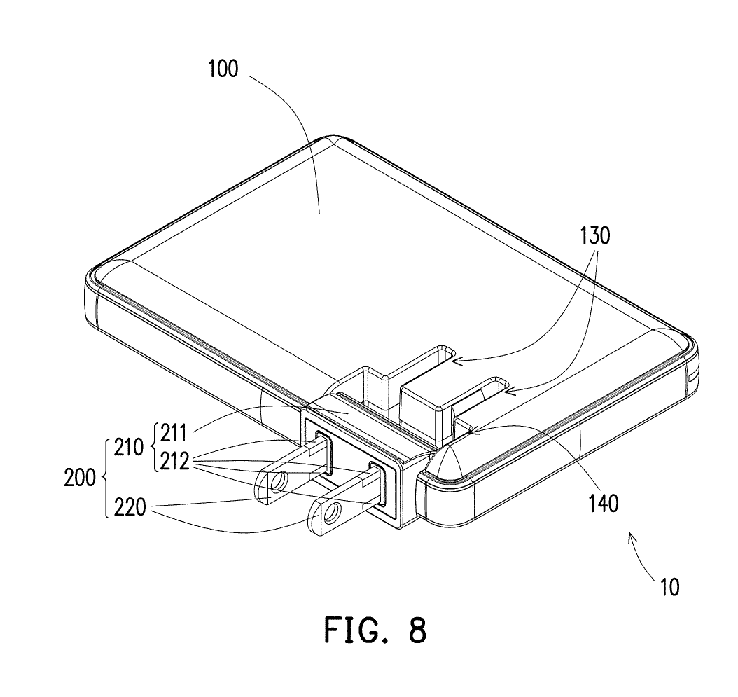

FIG. 5 is a three dimensional and exploded schematic view of a power adaptor with a plug according to another embodiment of the disclosure, FIG. 6 is a schematic top view of the power adaptor in FIG. 5, FIG. 7 is a three dimensional schematic view of a plug in FIG. 5 at a first position, and FIG. 8 is a three dimensional schematic view of the plug in FIG. 5 at a second position. Referring to FIG. 5, the body 100 includes a first portion 110 and a second portion 120 assembled with each other, and the power adaptor 10 further includes a camshaft assembly 300, and the insulating housing 210 is rotatably connected to the body 100 through the camshaft assembly 300. To be more specific, as shown in FIGS. 5 and 6, the body 100 has at least one slot 130. The number of the slots 130 is two in FIG. 6 as an example, the disclosure is not limited thereto as long as the number of the slots 130 is equal to the number of the blades 220. The insulating housing 210 is rotated through the camshaft assembly 300 to drive the blades 220 to retract within the slots 130 or leave the slots 130. Further, the body 100 has a recess 140 connected to the slots 130, the insulating housing 210 is at least partially located in the recess 140. That is to say, the plug 200 can be rotated with respect to the body 100 through the camshaft assembly 300 in a way that the insulating housing 210 of the plug 200 is partially located in the recess 140 of the body 100 and the blades 220 of the plug 200 can be retracted within or can leave the slots 130 of the body 100. Therefore, the plug 200 can be easily retracted within the body 100 when the power adaptor 10 is not recharged so that the power adaptor 10 has a compact design. On the other hand, the plug 200 can be conveniently rotated to plug in an electric power source so as to recharge the power adaptor 10.

After leaving the slots 130 of the body 100, the plug 200 may be suspended at a first position as shown in FIG. 7 and may be suspended at a second position as shown in FIG. 8. At the first position, the plug 200 and, the body 100 form an angle of 90 degrees. At the second position, the plug 200 and the body 100 form an angle of 180 degrees. However, the disclosure is not limited thereto, in other embodiments, the plug 200 may be suspended at many positions and form an angle from 0 degree (full retracted position) to 180 degrees or more.

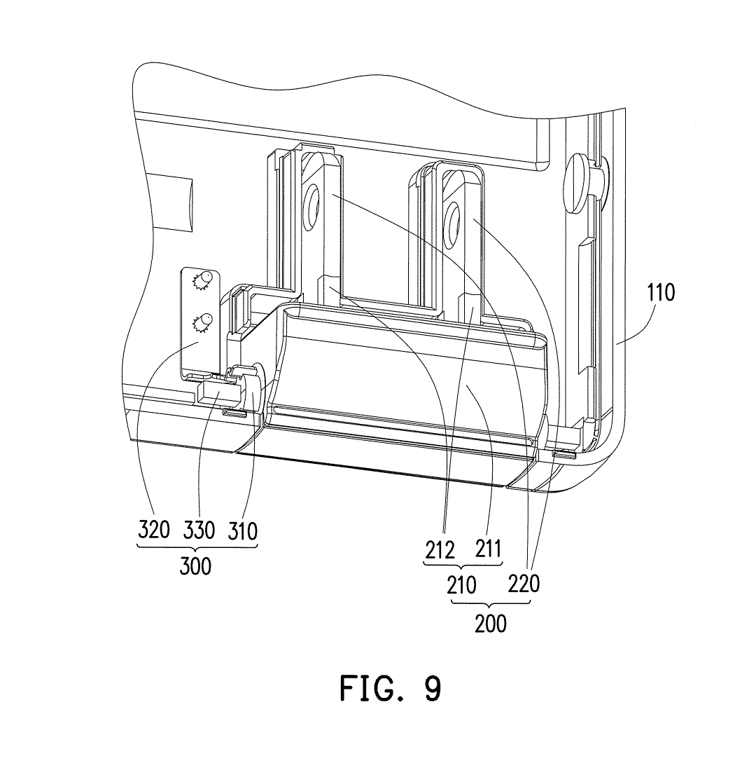

FIG. 9 is a three dimensional and partial view illustrating the camshaft assembly in FIG. 5. The camshaft assembly 300 includes a cam 310, an elastic component 320, and a shaft 330, the insulating housing 210 is rotatably connected to the body 100 through the shaft 330, the cam 310 sleeves on the shaft 330, and the elastic component 320 connects to the body 100 and suspends the plug 200 at different positions. However, the disclosure is not limited thereto, the cam 310 may be integrally connected to the insulating housing 210. For example, the cam 310 and the insulating housing 210 can be forming at the same time by one manufacturing process, such as molding.

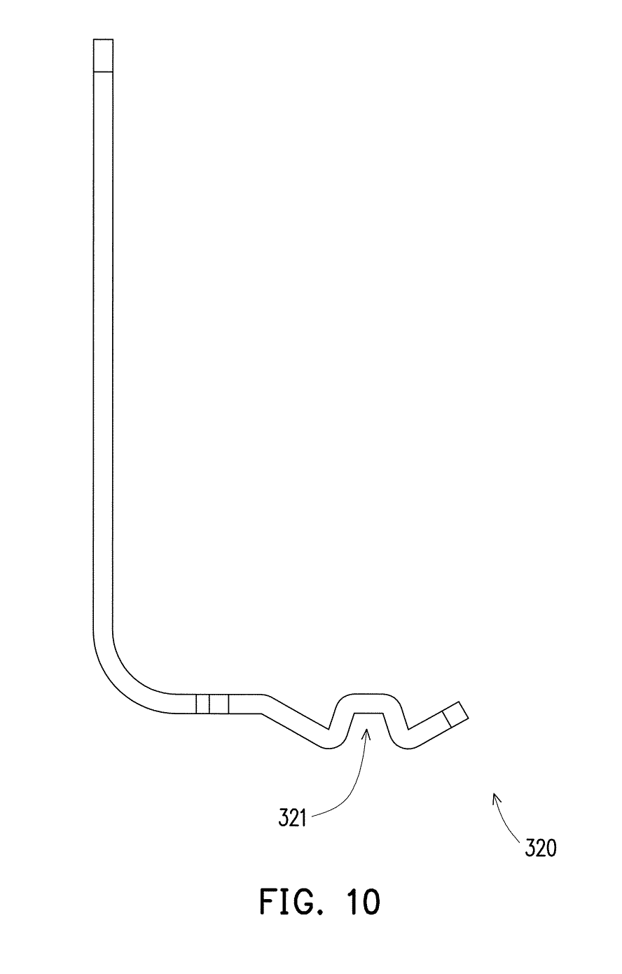

FIG. 10 is a schematic side view illustrating an elastic component according to the embodiment in FIG. 4. Referring to FIGS. 4 and 10, the cam 310 has a plurality of protrusions 311, and the elastic component 320 has an indentation 321 fitting with any one of the protrusions 311. When the insulating housing 210 of the plug 200 is rotated, the elastic component 320 is bent with different degrees and the indentation 321 moves relatively to the cam 310 from one of the protrusions 311 to another one of the protrusions 311. However, the disclosure is not limited thereto, the elastic component 320 may have more than one indentation 321, and one of the indentations 321 of the elastic component 320 fits with any one of the protrusions 311. When the insulating housing 210 of the plug 200 is rotated, each of the indentations 321 moves relatively to the cam 310 from one of the protrusions 311 to another one of the protrusions 311. In some embodiments, the cam 310 is configured as a disk-like or gear-like shape with one or more protrusions 311 along the edge of the cam 310.

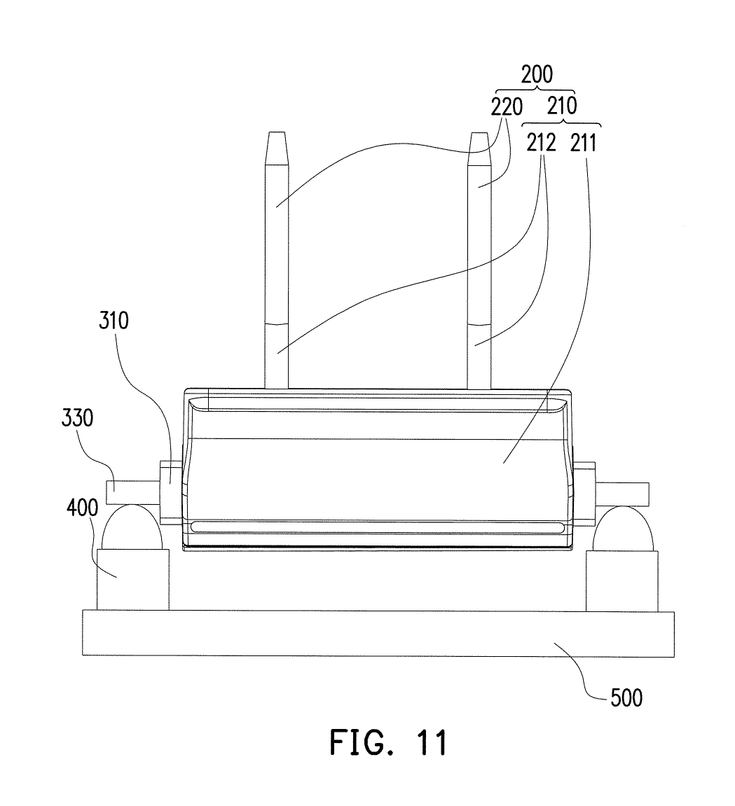

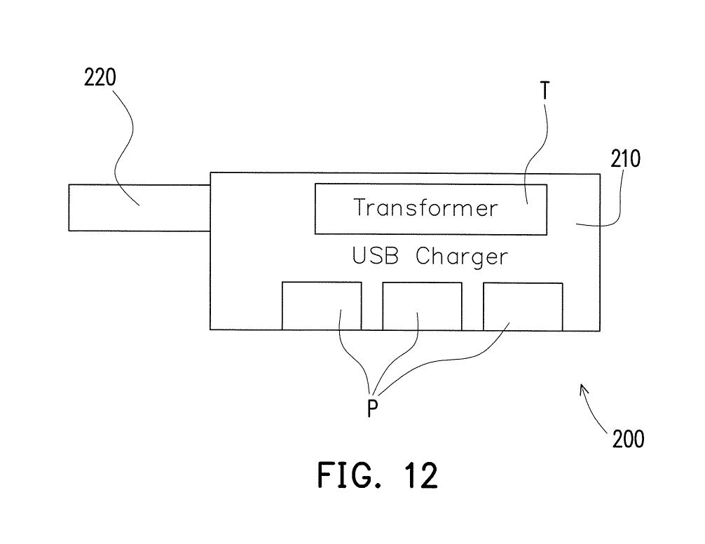

FIG. 11 is a schematic view illustrating an electrical connection component according to yet another embodiment of the disclosure. Referring to FIG. 11, the power adaptor further includes at least one electrical connection component 400 disposed in the body 100 and contacting the shaft 330. To be more specific, the electrical connection component 400 connects the shaft 330 with a circuit 500, so as to conduct the current from the blades 220 through the shaft 330 to the circuit 500 when the blades 220 of the plug 200 are inserted into an electrical power source. The electrical connection component 400 may be a pogo pin. In FIG. 12, two electrical connection components 400 are shown for example only, and the electrical connection component 400 may be other appropriate components which can conduct a current from a rotating shaft.

FIG. 12 is a schematic view illustrating electrical connection of a power adaptor according to yet another embodiment of the disclosure. Referring to FIG. 12, the power adaptor 200 may further include a battery (not shown), a transformer T, a plurality of output ports P. When the blades 220 of the plug 200 are inserted into an electrical power source, the electrical power is stored in the battery. The electrical power stored in the battery is converted by the transformer T in order to charge other portable electronic devices through the output ports P.

The power adaptor 10 may utilize an ultra-thin transformer T to convert AC power into DC power for charging portable electronic devices. The transformer T is assembled in a compact configuration such that the transformer T may be accommodated in the thin body 100 of the power adaptor 10 while the transformer T also supports the power transformation efficiently.

Moreover, the power adaptor 10 uses unique capacitors which are in special packages to fit in the thin body 100 of the power adaptor 10.

The output ports P may comply with the Universal Serial Bus (USB) standard for compatibility with USB powered devices. The output ports P accommodate USB cables that transfer power to connected portable electronic devices, such as cell phone, electronic tablet, camera, headphone, wearable devices or any other portable device.

Summarily, in the disclosure, a part of each of the blades protruding out from the base is partially covered by the extending portions. Therefore, it is safer for the user when plugging the power adaptor into the external power source. Further, the condition D²+L²=(D+T)² is satisfied in the disclosure, so the distance between the edge of the base to the exposed blade becomes the shortest distance from the edge of the base to the second section of the blade instead of the distance D, which is the distance between the edge of the base and the extending portion. In other words, the distance between the edge of the base to the exposed blade is equal to square root of (D²+L²) and is equal to (D+T) instead of the distance D. Under the circumstance that the minimum distance between the edge of the base and the exposed blade is required, the sum (D+T) is equal to the minimum distance. That is to say, in the disclosure, the distance D between the edge of the base and the extending portion can be reduced while the condition of required minimum distance is still satisfied by increasing the thickness T so the edge of the base can be designed to locate closer to the extending portion/blade. Therefore, the base of the insulating housing can be designed to have a smaller thickness. Consequently, the plug together with the body can be designed to have a smaller thickness. That is to say, the thickness of the power adaptor is reduced while satisfying safety requirement.

Further, the plug can be easily retracted within the body through the camshaft assembly when the power adaptor is not recharged so that the power adaptor has a compact design. On the other hand, the plug can be conveniently rotated to plug in an electric power source so as to recharge the power adaptor.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A power adaptor, comprising:
a body; and
a plug, comprising an insulating housing and at least one blade partially inserted into the insulating housing, wherein the insulating housing is connected to the body and comprises a base and at least one extending portion extending from the base, a part of the blade protruding out from the base is partially covered by the extending portion, a distance between an edge of the base and the extending portion is D, an extending length of the extending portion is L, a thickness of the extending portion is T, and D²+L²=(D+T)².

2. The power adaptor as recited in the claim 1, wherein D²+L²=26.01 mm².

3. The power adaptor as recited in the claim 1, wherein the extending portion extends from the base along a first direction, the part of the blade protrudes out from the base along the first direction, the distance between the edge of the base and the extending portion along a second direction is D, the extending length of the extending portion along the first direction is L, the thickness of the extending portion along the second direction is T, and the first direction is perpendicular to the second direction.

4. The power adaptor as recited in the claim 1, wherein the blade comprises a first section and a second section, the first section is embedded in the insulating housing, the second section is connected to the first section and exposed by the insulating housing, and a width of the first section is smaller than a width of the second section.

5. The power adaptor as recited in the claim 4, wherein a width of the extending portion is equal to the width of the second section.

6. The power adaptor as recited in the claim 1, further comprising a camshaft assembly, wherein the insulating housing is rotatably connected to the body through the camshaft assembly.

7. The power adaptor as recited in the claim 6, wherein the body has at least one slot, the insulating housing is rotated through the camshaft assembly to drive the blade to retract within the slot or leave the slot.

8. The power adaptor as recited in the claim 7, wherein the body has a recess connected to the slot, the insulating housing is at least partially located in the recess.

9. The power adaptor as recited in the claim 6, wherein the camshaft assembly comprises a cam, an elastic component, and a shaft, the insulating housing is rotatably connected to the body through the shaft, the cam sleeves on the shaft, and the elastic component connects to the body and suspends the plug at different positions.

10. The power adaptor as recited in the claim 9, wherein the cam is integrally connected to the insulating housing.

11. The power adaptor as recited in the claim 9, wherein the cam has a plurality of protrusions, and the elastic component has an indentation fitting with any one of the protrusions.

12. The power adaptor as recited in the claim 11, wherein the indentation moves relatively to the cam from one of the protrusions to another one of the protrusions when the insulating housing is rotated.

13. The power adaptor as recited in the claim 6, further comprising at least one electrical connection component disposed in the body and contacting the shaft.

14. The power adaptor as recited in the claim 13, wherein the electrical connection component is a pogo pin.
